(19) United States
(12) Patent Application Publication
(10) Pub. No.: US 2010/0099064 A1
(43) Pub. Date: Apr. 22, 2010

(54) COLLECTIBLE CENTRIC EDUCATIONAL GAME SYSTEM

(76) Inventors: Koji Kato, Bellevue, WA (US); Jeremiah Stewart Jamison, Redwood City, CA (US)

Correspondence Address: MICHAEL RIES, 318 PARKER PLACE, OSWEGO, IL, 60543, US

(21) Appl. No.: 12/581,157

(22) Filed: Oct. 18, 2009

Related U.S. Application Data
(60) Provisional application No. 61/106,583, filed on Oct. 19, 2008.

(51) Int. Cl. G09B 19/00

(52) U.S. Cl. 434/156

(57) ABSTRACT

Children exhibit curiosity and desire to acquire things of interest from their earliest stages. This eventually evolves into their lust for toys, dolls, stickers, books, clothing, having books read to them, being allowed to watch TV, and more. Things of a child's interest are generically referred to as ‘collectibles’ hereafter. A game system that overlays educational content with in-game collectibles is presented. The more in-game collectibles the player has the more fun they have. This paradigm converts the lust for in-game collectibles into a lust to learn. A virtuous cycle emerges where (i) anticipation to acquire the next educational content builds up, and then (ii) this anticipation is gratified when the educational content is finally acquired, and (iii) the educational content is naturally appreciated until the child moves onto the next collectible.

### REFERENCE TO RELATED APPLICATIONS

This patent application claims the benefit of U.S. Provisional Application No. 61/106,583 filed on Oct. 19, 2008, the disclosure of which is incorporated herein in its entirety by reference.

### BACKGROUND OF THE INVENTION

1. Field of the Invention

The present invention relates generally to a game and more particularly to a method which aligns educational intention with the basic behavior of children where the game makes use of collectibles to empower a player to become more involved.

2. Description of Related Art

Many attempts have been made to leverage computers as a learning tool in education. The various attempts fall into three categories as follows: A) Traditional show and tell educational media ported to computers; B) Question and answer educational media ported to computers; and C) Task oriented environments built on computers.

An example of category A is effectively the same as watching educational TV programs, although on a computer.

U.S. Pat. No. 7,150,630 titled “Method and Apparatus for Automated Training of Language Learning Skills” by Budra, is an example of category B. Although this example utilizes computer multimedia capabilities to produce a fun experience and create engagement, it is not significantly different from traditional question and answer style learning. It is often difficult to retain engagement to the degree of real games with this approach as it is basically a study workbook.

U.S. Pat. No. 7,402,105 titled “Massively Multiplayer Educational Online Role Playing Game” by Hutter is an example of category C. Although this example creates a dynamic environment in which tasks are executed while learning, a simple central game pattern doesn't exist thus making the experience difficult to comprehend. This is challenging to pre-teen children which limits the audience.

What is needed is a collectible centric educational game which is a learning tool that overlays educational content onto in-game collectibles such as items that a child wants to collect.

### SUMMARY OF THE INVENTION

The collectible centric educational game disclosed is a learning tool that overlays educational content onto in-game collectibles where a collectible is an item of desire.

From a child's game play point of view, there is no difference from playing a pure entertainment game which has items or spell as representative collectibles. Wielding the items or spell allows the player, for example, to go to new areas, acquire treasures which could not be reached before, and defeat enemies which could not be defeated before. Since the game is purely entertainment, the child's engagement is better retained as compared to a workbook turned software solution.

The game is also designed so that even pre-teen children can easily enter into the experience by having a simple central game pattern which is about collecting items or words

The game disclosed make use of collectibles to empower a player to do more things. This activates the Collectibles education virtuous cycle to amplify and retain the child's engagement.

It is an object of the invention to provide a game which overlays what is desired to be learned—the educational content—with the core collectibles within that game.

It is another object to provide a game which has a persisted collectible repository maintained per player. This collectible repository also stores usage information of the collectibles.

It is another object to provide a game which has a means to view collectibles earned to date.

It is another object to provide a game which is designed to make such collectibles within that game tradable/buyable/sellable/borrowable among players.

It is another object to provide a game which has a reporting system built around the collectibles repository within that game, although not limited to merely reporting statistics on collectibles.

It is another object to provide a game which has auxiliary means to acquire the collectibles besides picking up the collectibles directly on games.

It is another object to provide a game which utilizes collectibles in a repository to enhance the game.

It is another object to provide a game which has multiple modes of game play, mapped to the cognitive aptitude of the player for the educational content.

It is another object to provide a game which has an adaptive controller which reveals games to the player based on their collectible performance.

It is another object to provide a game which targets English education where the primary collectibles are words and phrases, referred to as magic words in the game.

It is another object to provide a game which targets English education where the primary repository is a spell book.

It is another object to provide a game which targets English education where a spell book view shows words earned to date.

It is another object to provide a game which targets English education where the portable state of a word is represented as a capsule that can be traded/bought/sold/borrowed.

It is another object to provide a game which targets English education where the reporting system shows;
A) How many words were acquired or used every day;
B) How many times the desired/undesired words were used every day.

It is another object to provide a game which targets English education where the auxiliary means to acquire words is via earning coins in mini games which can later be used to purchase words.

It is another object to provide a game which targets English education where the auxiliary means to acquire words is via earning coins in mini games which can later be used to gain a word from a random vending machine.

It is another object to provide a game which targets English education where collectibles can be used to decorate a player avatar, his/her pet avatar, or a person's personal room.

It is another object to provide a game which targets English education where one of the games is a maze-like adventure game where the player needs to command their pet via words.

It is another object to provide a game which targets English education where there are three modes of game play which are Simple, Power-up, and Combination.

In an embodiment there is disclosed a method for using a game for teaching English to a child of between 5 and 10 where English is the child's second language on a computing device by graphically providing a word which is a first command word for a pet and graphically presenting the pet as an avatar. The pet will graphically perform the command only when the child selects the single command word.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of a collectible centric educational game system in accordance with the principles of the invention; and

FIG. 2 is a flow diagram of a game in accordance with the principles of the invention.

### DESCRIPTION OF THE PREFERRED EMBODIMENT

Children exhibit curiosity and desire to acquire things of interest from their earliest stages. This eventually evolves into their lust for toys, dolls, stickers, books, clothing, having books to read, being allowed to watch TV, and so on. Things of a child's interest are generically referred to as “collectibles” hereinafter.

There is disclosed a game that overlays educational content with in-game collectibles. The more in-game collectibles a player has, the more fun he/she will have. This paradigm converts the lust for in-game collectibles into a lust to learn. A virtuous cycle emerges where: A) Anticipation to acquire the next educational content builds up, and then, B) This anticipation is gratified when the educational content is finally acquired, and C) The educational content is naturally appreciated until the child moves onto the next collectible.

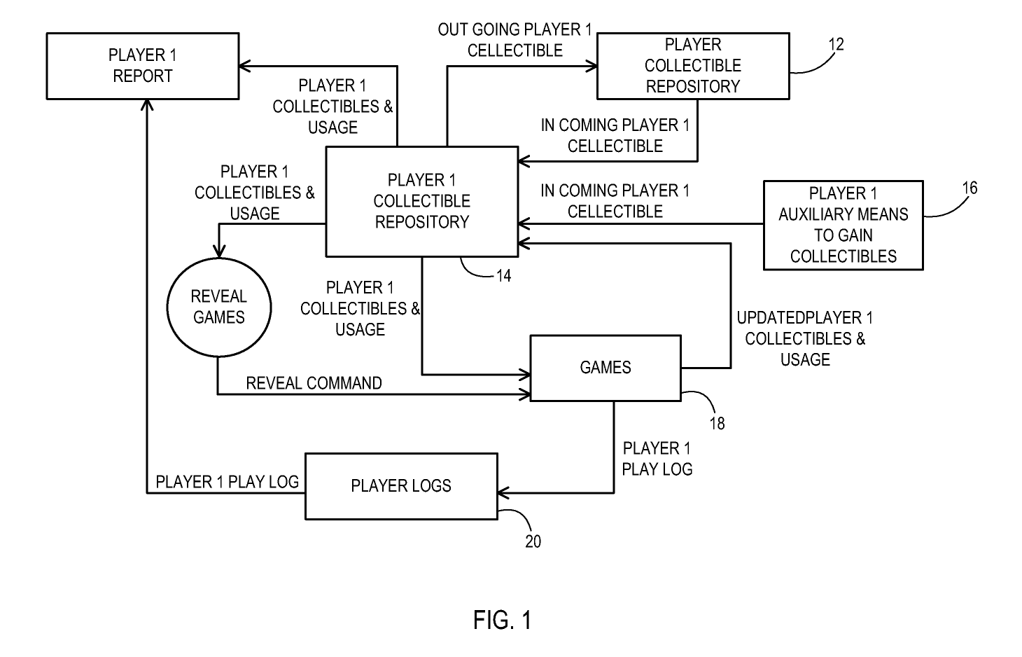

Referring to FIG. 1 there is disclosed a flow diagram of collectible centric educational game system context in accordance with the principles of the invention.

Games using the flow diagram can be implemented in many environments which can include, but are not limited to: A) stand alone installations on computers where no network technology is used, B) stand alone installations on a computer where networks are used to enable player interaction, or C) internet browser applications on a computer where the game is downloaded from a web server.

FIG. 1 is a flow diagram of a collectible centric English education game. Within this specific embodiment, each of the elements in the diagram of FIG. 1 is instantiated as follows:

Player No. 1 Collectible repository, block 14, includes:
Word book with English words, English phrases;
Capsule holder;
Player's wardrobe; and
Player's room;

Player No. 1 auxiliary means to gain collectibles, block 16. includes;
Shop word capsules which are words in portable form;
Shop has a random vending machine which lets the player converts coins into capsules;
Shop sells clothing to customize the player avatar and pet; and
Shop sells furniture to furnish the player's room;

Games, block 18, includes:
Eight mini games; and
One of eight games, the Mystic Room.

The Collectible centric English educational game disclosed is a world of magic. It is designed for pre-teen children around the ages of 5 to 10. It is directed toward teaching English as a second language in a foreign country such as Japan.

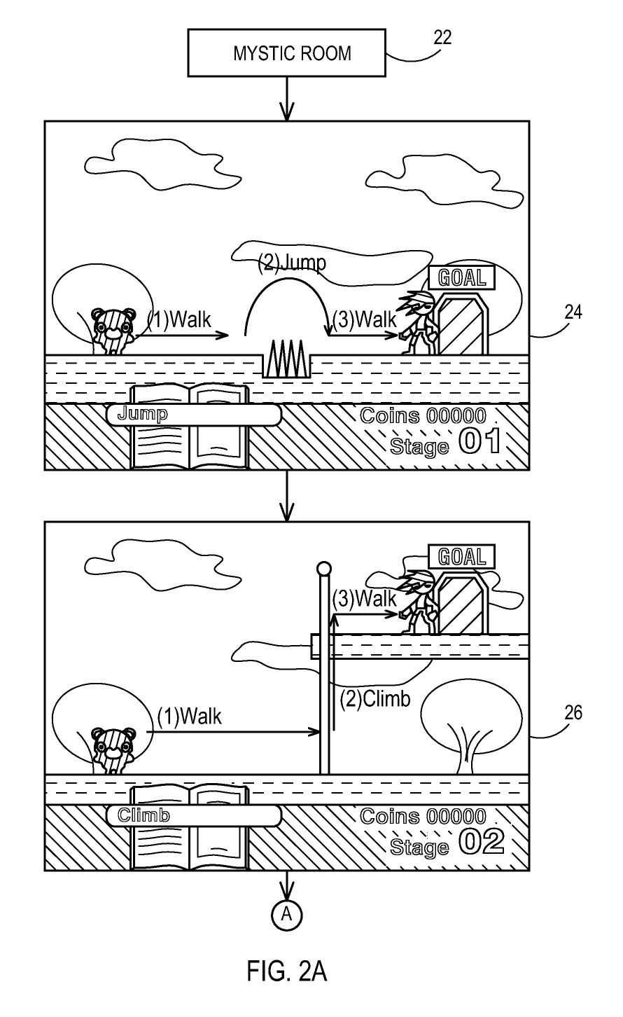

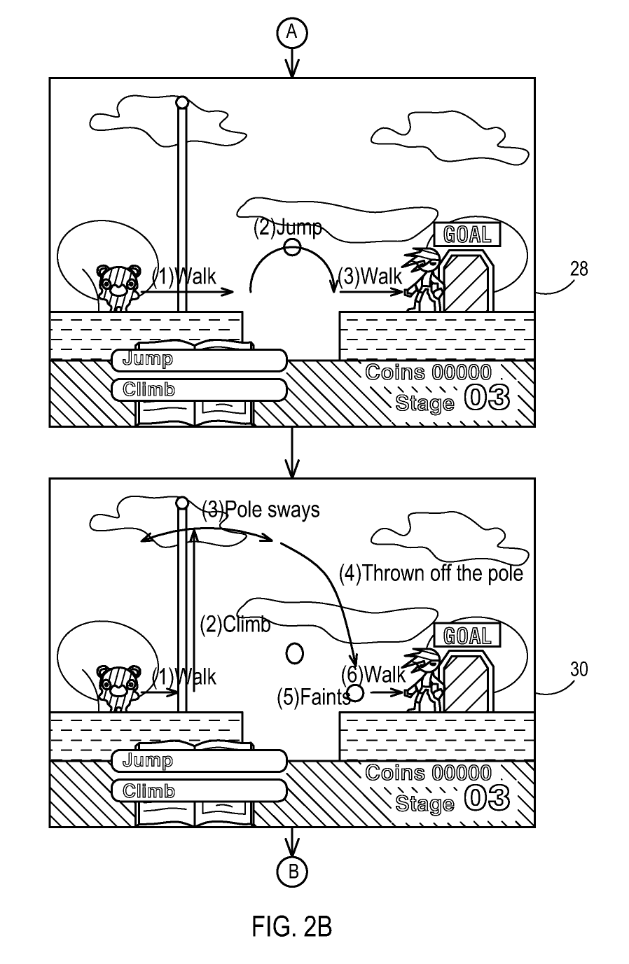

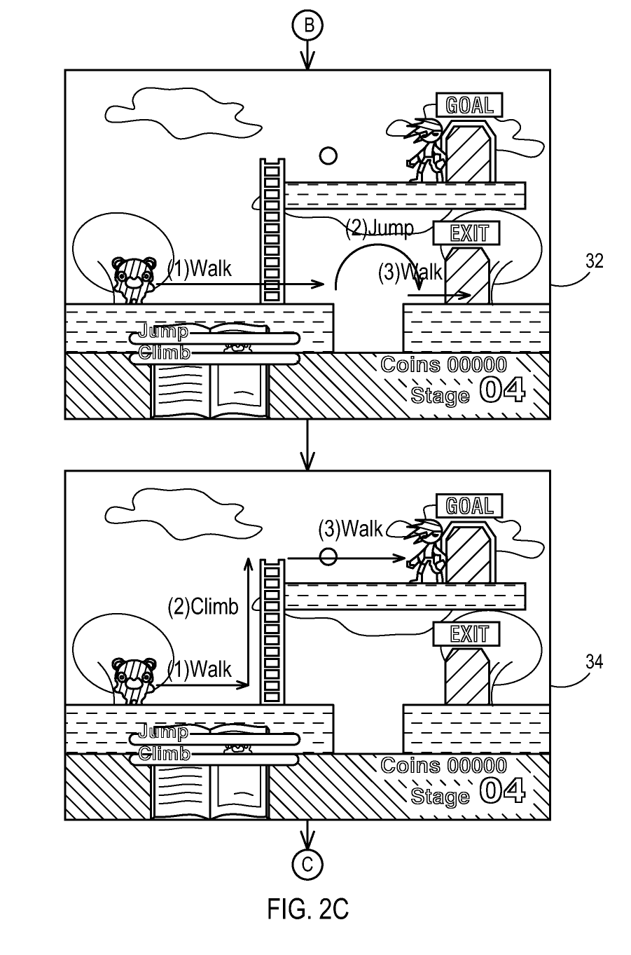

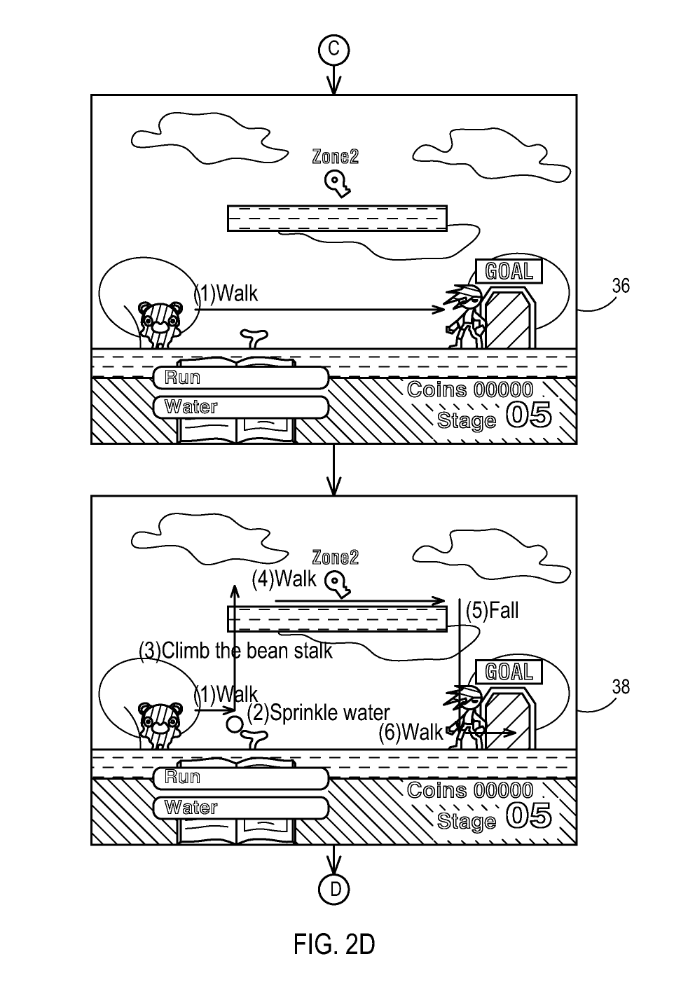

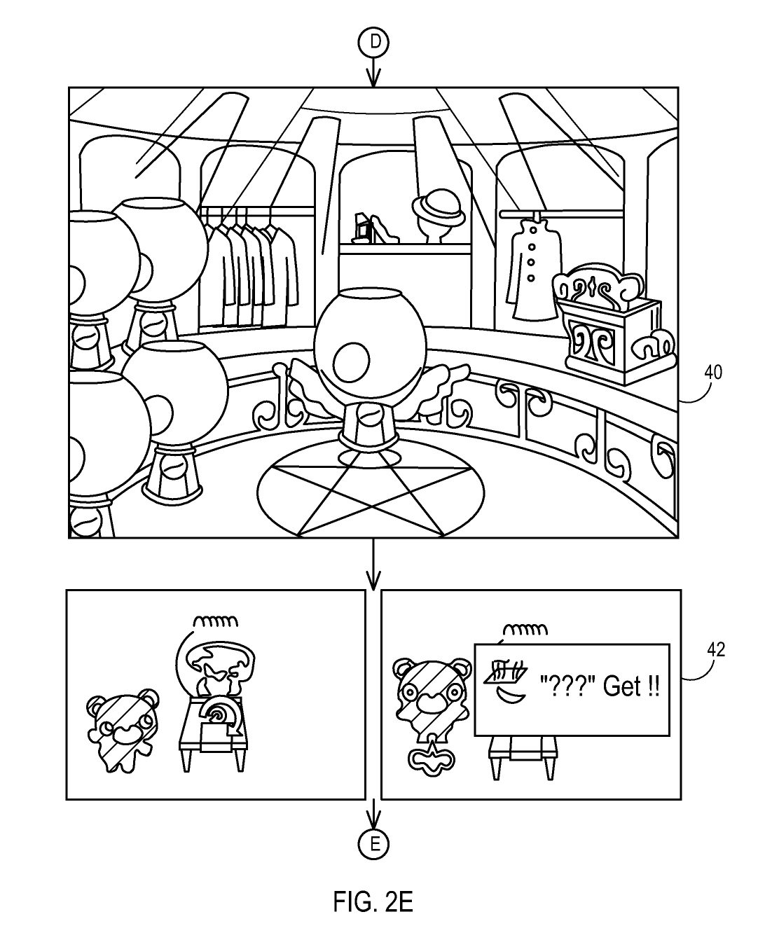

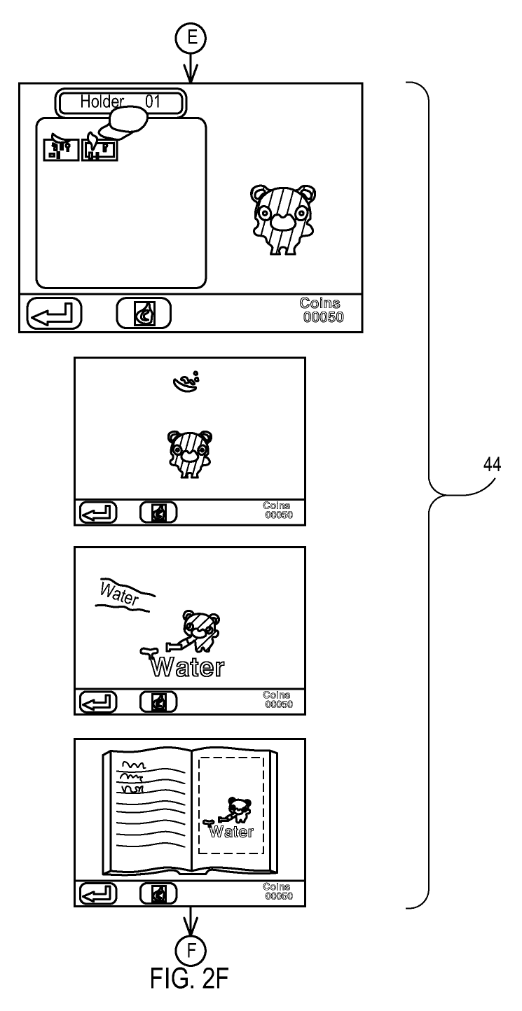

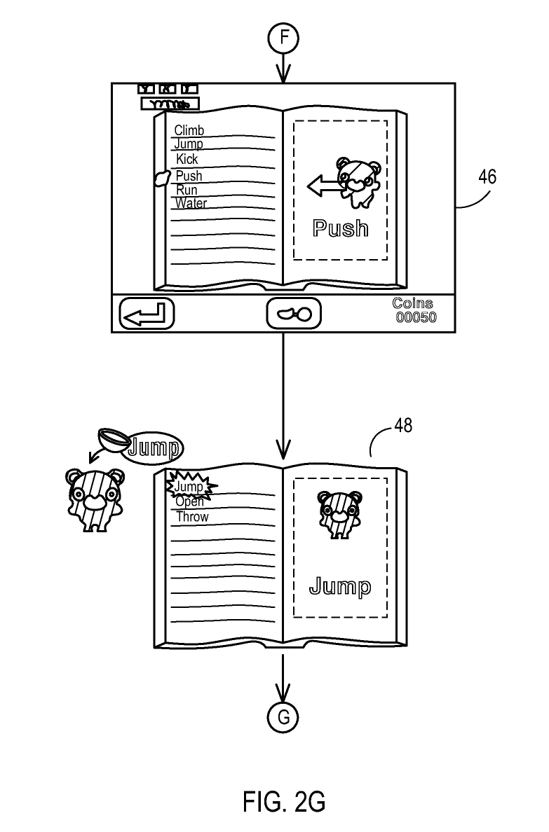

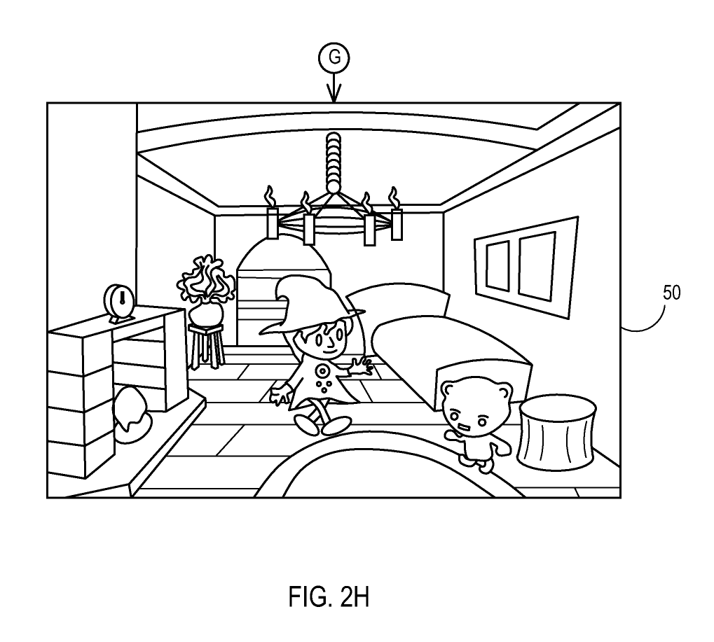

In the embodiment that follows a player avatar commands his/her pet with words to play the game. The more words a player can identify, the more things the pet can do. At block 18 a player enters a game and chooses Mystic Rooms, block 22 of FIG. 2. In the game Mystic Rooms the player commands his/her pet with preselected words. If the player does not select the proper word, the pet cannot move to the next step.

Continuing with FIG. 2, block 24, the player has only the word “Jump” to choose. When the player clicks on the word “Jump”, the pet walks, then hops over the spikes and walks to the goal, the target. At the next step, block 26, the player has only the word “climb” to choose. Upon choosing this word, the pet walks, then climbs the pole, and then walks to the goal. This lets the player advance to block 28 where the player has two words, “jump” and “climb” to choose from. When the player clicks “jump”, the pet walks, jumps across the opening, gets a coin, and then walks to the goal.

At the next step, block 30, the player now selects “climb” and the pet walks\and then climbs the pole. The pole begins to shake and sway and the pet falls off, hits the ground and faints. Finally the pet stands up and walks to the goal. At the next step, block 32, if the player had selected :jump:, the pet walks, then jumps across the opening, and then walks to the exit. When the pet enters the exit the player leaves the Mystic Room game. If the player selects “climb”, block 34, the pet walks, then climbs the pole, and walks to the goal. This lets the player advance to the next step where the player can choose between “run” and “water”. If the player selects “run”, block 36, the pet walks to the goal and the program advances to the next step. If the player had selected the word “water”, block 38, the pet walks, then sprinkles the bud, hops on the bud while it grows into a bean stalk, walks again, gets a key, falls, and walks again to the goal.

The key allows the player to advance to zone two. The Mystic Room has 100 stages, more or less. Keys let a player re-enter from a higher stage rather than from stage 1 all over again. Within the Mystic Room the player will receive coins, capsules (for words), clothing, furniture, and other special items. Once a player receives coins, he/she can go to a shop, block 40, to purchase clothing, furniture, and in some instances capsules for words, or use a vending machine, block 42, to get a capsule for words which is cheaper, but the player does not have control of the capsule received.

Upon receiving a capsule, the player feeds it to the pet to power the word and store the word in the spell (word) book, block 44. The spell book stores all words and phrases in English, block 46. Phrases are synthesized from multiple capsules which are required for the phrases. The spell book is also a magic book where, by clicking on a word or a phrase the right side page of the book becomes animated and the action is demonstrated by a caricature pet, block 48. A player's home is where he/she can store non-spell collectibles such as clothing and furniture.

The game described above can be summarized as a “collectibles” English education virtuous cycle that includes the following steps in sequence: Step A, start to play a mini game; step B, acquire a coin; step C, convert a coin to a capsule; step D, give the capsule to the pet; step E, gain words and or phrases; and step F, use the words learned in other mini games.

In another embodiment a number of simple games, power-up games, and combination games that offer a progressing model that fits the cognitive aptitude and behavior of children can be provided. For example, one such game can be “Magical Half pipe” where score tricks are preformed at the high point of the pipe; and Encouragement English is spoken when a trick works.

Another game can be “Magical Storm” where:

Player commands a pet via words to shoot down debris in a storm;

Initially it is merely picture matching which then evolves into word to picture matching;

Only known spell objects can be shot down; and

Bullet limits and hit points for the pet turret apply.

Another game can be “Mystical Rooms” where;
One screen is one room;
The player makes one choice from four words in their spell book;
Easy words let the player exit the room;
Advanced words let the player go to advanced rooms;
Later this game evolves into a combination model where the more words a player has the more advantageous the player becomes; and
A culture room can be introduced such as the New York room.

Another game can be “Magical Dungeons” where:
The game is a dungeon exploration action game;
Uses words at first then phrases to explore the dungeon;
Confronted with gimmicks, traps, and enemies that must be solved/defeated with words; and
Goal is to get the treasure at the lowest level.

Another game can be “Phase Battlers” where:
Phrases are used to battle one another. Initially the game will be winning against ten Central Processing Unit players. Eventually a second player will be introduced;
The attack effect is reflective of the phrase action. There is a ‘catch it all’ attack effect for non-important phrases; and
Strength of the phrase is based on predefined rules and attribution of the phrases, e.g., water phrases are stronger than fire phrases.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A method for using a game for teaching English to a child of between 5 and 10 where English is the child's second language on a computing device, the method comprising:
graphically providing a word which is a first command word for a pet;
graphically presenting an avatar as a pet;
requiring the child to select said single word to urge said pet to perform the command.

2. The method of claim 1 further comprising:
graphically presenting a second word which is a second command for the pet;
wherein said first word, if selected by the child, will urge the pet to move to a target which will allow the child to continue to a next step, and said second word, if selected by the child, will urge the pet to move away from the target and prevent the child from continuing to the next step.

3. The method of claim 2 wherein third and fourth words are graphically presented wherein the third word directs the pet to a target to allow the child to continue to a next step and said fourth word will urge the pet to move away from the target and prevent the child from continuing to the next step.

4. The method of claim 3 wherein as the child continues to advance, a graphical representation of reward is provided which allows the child to graphical purchase something of value.

5. The method of claim 4 wherein said something of value is at least a coin.

6. The method of claim 5 wherein, upon receiving a coin, the child can go to a shop to purchase clothing or furniture.

7. The method of claim 5 wherein, upon receiving a coin, the child can go to a shop to purchase a specific capsule for words.

8. The method of claim 5 wherein, upon receiving a coin, the child can go to a vending machine to get a capsule for words which is less expensive than the capsule from a shop but there is no control over the capsule received.

9. The method of claim 7 wherein the capsule is graphically fed to the pet to power the word and store the word in a spell book.

10. The method of claim 9 wherein phrases are synthesized from multiple capsules which are required for the phrases which are stored in the spell book.

11. The method of claim 10 wherein a word or a phrase selected in the spell book causes the pet graphically represented on a page of the book to graphically demonstrate the selection.

12. The method of claim 1 further comprising:
providing the child with a coin upon selecting the word;
converting the coin to a capsule;
giving the capsule to the pet;
gaining words and/or phrases; and
using the words learned with new words which can be learned in other games.

13. The method of claim 1 wherein the pet is commanded via graphically presented words to shoot down debris in a storm which is initially picture matching that evolves into at least one word to picture matching where only known word objects can be shot down.

14. The method of claim 1 further comprising:
locating the child in a room upon selecting the word;
selecting one word from four words;
allowing the child to exit the room when selecting an easy word; and
allowing the child to go to an advanced room when selecting a difficult word.

15. The method of claim 1 further comprising;
locating the child in a dungeon upon selecting the word; and
confronting the child with gimmicks, traps and enemies that require solutions with words;
wherein the goal is to get a treasure upon resolving all obstacles.

16. A method for using a game for teaching English to a child of between 5 and 10 where English is the child's second language on a computing device, the method comprising:
providing the child with a pet avatar that obeys commands provided by the child;
commanding the pet avatar with at least one preselected word from one or more provided words where only some of the provided words is a correct word;
providing the child with a coin upon selecting the correct word;
providing a collectible repository for the player; and
providing the player's collectible repository with collectibles purchased by said child with said coin.

17. The method of claim 16 wherein said player's collectible repository is a room for the player.

18. The method of claim 16 wherein the coins collected by the player increases as the number of correct words that are selected increases.

19. The method of claim 16 wherein said player's collectible repository is a word book for the player.

20. The method of claim 16 wherein the command that the child can issue to the pet avatar is limited to the commands in the collectable repository.
